(19) United States
(12) Patent Application Publication
(10) Pub. No.: US 2014/0335857 A1
(43) Pub. Date: Nov. 13, 2014

(54) CELL SEARCH METHOD

(71) Applicant: Electronics & Telecommunications Research Institute, Daejeon (KR)

(72) Inventors: Jun Hwan LEE, Seoul (KR); Tae Soo KWON, Daejeon (KR)

(73) Assignee: Electronics & Telecommunications Research Institute, Daejeon (KR)

(21) Appl. No.: 14/272,743

(22) Filed: May 8, 2014

(30) Foreign Application Priority Data
May 8, 2013 (KR) 10-2013-0051915
May 7, 2014 (KR) 10-2014-0053917

(51) Int. Cl. H04W 48/16

(52) U.S. Cl. CPC H04W 48/16
USPC 455/434

(57) ABSTRACT

A cell search method is disclosed. In an environment that a plurality of small cells are located around a macro cell, a macro base station may allocate a terminal-specific signal distinguishing a terminal from other terminal to the terminal which establishes a connection with the macro base station, and share information of the terminal-specific signal with a plurality of small cell base stations. When a cell search is triggered, the terminal may transmit the allocated terminal-specific signal, and the plurality of small cell base stations perform measurements on the received terminal-specific signal and then report the measured results to the macro base station. The macro base station may configure a candidate set of small cells for the terminal based on the measurement results reported from the plurality of small cell base stations, and transmit the candidate set to the terminal.

### CLAIM FOR PRIORITY

This application claims priorities to Korean Patent Applications No. 10-2013-0051915 filed on May 8, 2013 and No. 10-2014-0053917 filed on May 7, 2014 in the Korean Intellectual Property Office (KIPO), the entire contents of which are hereby incorporated by reference.

### BACKGROUND

1. Technical Field

Example embodiments of the present invention relate in general to a technology for small cell enhancements, and more specifically, to a method for searching cells that enables a terminal to search cells easily in a multi-cell environment.

2. Related Art

Due to wide distribution of mobile terminals and tablet PCs and rapid advancement of mobile computing based on wireless internet technologies, innovative increase of wireless network capacity is being demanded.

In many studies, it is predicted that traffic amount of mobile users will increase rapidly. An adoption of a new advanced physical layer technology or allocation of additional spectrums is being considered as the representative solutions to satisfy the above rapid explosive increase of traffic amount.

However, technologies such as frequency modulation/demodulation, channel coding, and multi-antenna are already approaching their theoretical limits, and allocation of additional frequency spectrum also cannot be a fundamental solution for capacity expansion of cellular networks.

As an effort for enhancing capacities of wireless communication systems, a method, in which a plurality of small cells are used to maximize spatial frequency reuse ratio so as to enhance capacities which can be actually provided to users, is being focused currently. A miniaturization of a cell may have advantages in increasing user capacity and decreasing backward transmission power so that power consumption of a terminal may be reduced.

On the other hand, in order for a terminal to establish a connection with an arbitrary cell, or to perform handover for supporting mobility of the terminal, a technique for cell search is necessary. In an environment of small cells, since many cells exist around the terminal and the size of cells is small, frequent handover situations may occur. Accordingly, in such the small cell environment, neighbor cell searches may affect service qualities and power consumptions of the terminal. Therefore, fast, low-power consuming, and efficient cell search methods are needed for the small cell environment.

In the conventional cell search procedures, a terminal measures and compares signals (for example, synchronization signals) broadcasted by base stations, and then selects a serving cell based on the comparison result. Especially, in case of handover, a method, in which a terminal receives a measurement set list including information about neighbor cells from a serving base station and a terminal searches neighbor cells based on the received measurement set list, is used.

However, in a dense small cell environment, when a terminal measures signals transmitted from base stations without information provided from a network, cell search procedures are performed frequently due to a movement of the terminal so that overhead and power consumption due to the frequent cell searches may be increased. Meanwhile, when a terminal utilizes the measurement set list provided from a serving cell, if the macro base station cannot determine a current position of the terminal in a cell when the terminal moves from a macro cell to a small cell, there may be problems that the macro base station cannot configure the measurement set list correctly and the amount of information in the measurement set list increases. Also, even in the case that the terminal moves between small cells, since service area of each of small cells does not have a typical continuous shape differently from those of the conventional macro cells, a new cell search method which enables a terminal to recognize an irregular cell topology efficiently is demanded.

### SUMMARY

Accordingly, example embodiments of the present invention are provided to substantially obviate one or more problems due to limitations and disadvantages of the related art. Especially, the method of discovering adjacent devices or services is needed for providing various mobile services, such as a local advertisement targeting to potential customers, finding a taxi with vacant seats, a mobile game with adjacent gamers and finding vacant parking lots, without a help of GPS or intervening user.

Example embodiments of the present invention provide a cell search method in which a terminal can search neighbor cells fast and easily.

In an example embodiment, a cell search method performed in a terminal, the method may comprise being allocated a terminal-specific signal from a base station; and transmitting the terminal-specific signal when a cell search is triggered.

Here, the method may further comprise receiving information about a set of candidate cells corresponding to the terminal-specific signal from the base station; and performing a cell search based on the received information about the set of candidate cells.

Here, the terminal-specific signal is a sounding reference signal (SRS).

Here, the terminal-specific signal is a unique signal of the terminal by which a plurality of small cell base stations can distinguish the terminal from other terminal

Here, the terminal-specific signal is configured by using a resource predetermined by the base station and a plurality of small cell base stations.

In other example embodiments, a cell search method performed in a base station, the method may comprise allocating a terminal-specific signal to a terminal which establishes a connection with the base station; transmitting information about the terminal-specific signal to a plurality of small cell base stations; receiving measurement result information on the terminal-specific signal from the plurality of small cell base stations; and configuring a set of candidate small cells for the terminal based on the measurement result information.

Here, the terminal-specific signal is a sounding reference signal (SRS).

Here, the set of candidate small cells includes at least one small cell base station reception power of which is larger than a predetermined threshold power among the plurality of small cell base stations.

Here, the method may further comprise transmitting information about the set of candidate small cells to the terminal, wherein the information about the set of candidate small cells is transmitted to the terminal in a form of a measurement set list.

Here, the method may further comprise determining a small cell base station having the largest reception power as a serving base station for the terminal.

In other example embodiments, a cell search method performed in a small cell base station, the method may comprise receiving information about a terminal-specific signal allocated to a terminal from a base station; monitoring a resource corresponding to the terminal-specific signal based on the information about the terminal-specific signal; when the terminal-specific signal is received, performing measurement on the received terminal-specific signal; and transmitting a measurement result on the terminal-specific signal to the base station.

Here, in the performing measurement and the transmitting a measurement result, the terminal-specific signal is received two or more times, and measurement results are obtained by performing measurements on the received measurement results, and an average value of the measurement results is obtained and reported to the base station.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram explaining a method for searching cells which are located around a terminal;

FIG. 2 is a conceptual diagram explaining a small cell search method based on uplink signal measurements;

FIG. 3 is a conceptual diagram illustrating a method for small cell search according to an example embodiment of the present invention;

FIG. 4 is a flow chart illustrating a method for small cell search according to an example embodiment of the present invention;

FIG. 5 is a flow chart illustrating a method performed in a macro base station in a method for cell search according to an example embodiment of the present invention;

FIG. 6 is a flow chart illustrating a method performed in a small cell base station in a method for cell search according to an example embodiment of the present invention;

FIG. 7 is a flow chart illustrating a method performed in a terminal in a method for cell search according to an example embodiment of the present invention; and

FIG. 8 is a block diagram illustrating a configuration of a small cell base station performing a method for cell search according to an example embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Also, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may be connected to and controls a plurality of cells physically, in this case, the base station may be regarded to comprise a plurality of logical base stations. That is, parameters configured to each cell are assigned by the corresponding base station.

Also, the term “network” used in this specification may include a mobile internet such as a Wireless Fidelity (WIFI), a Wireless Broadband Internet (WiBro), and a World Interoperability for Microwave Access (WiMax). Also, it may include 2G cellular network such as a Global System for Mobile communication (GSM) and a Code Division Multiple Access (CDMA), 3G cellular network such as a Wideband Code Division Multiple Access (WCDMA) and a CDMA2000. Also, it may include 3.5G cellular network such as a High Speed Downlink Packet Access (HSDPA) and a High Speed Uplink Packet Access (HSUPA). Also, it may include 4G or beyond 4G cellular network such as a Long Term Evolution (LTE) and a LTE-Advanced.

Hereinafter, embodiments of the present invention will be described in detail with reference to the appended drawings. In the following description, for easy understanding, like numbers refer to like elements throughout the description of the figures, and the same elements will not be described further.

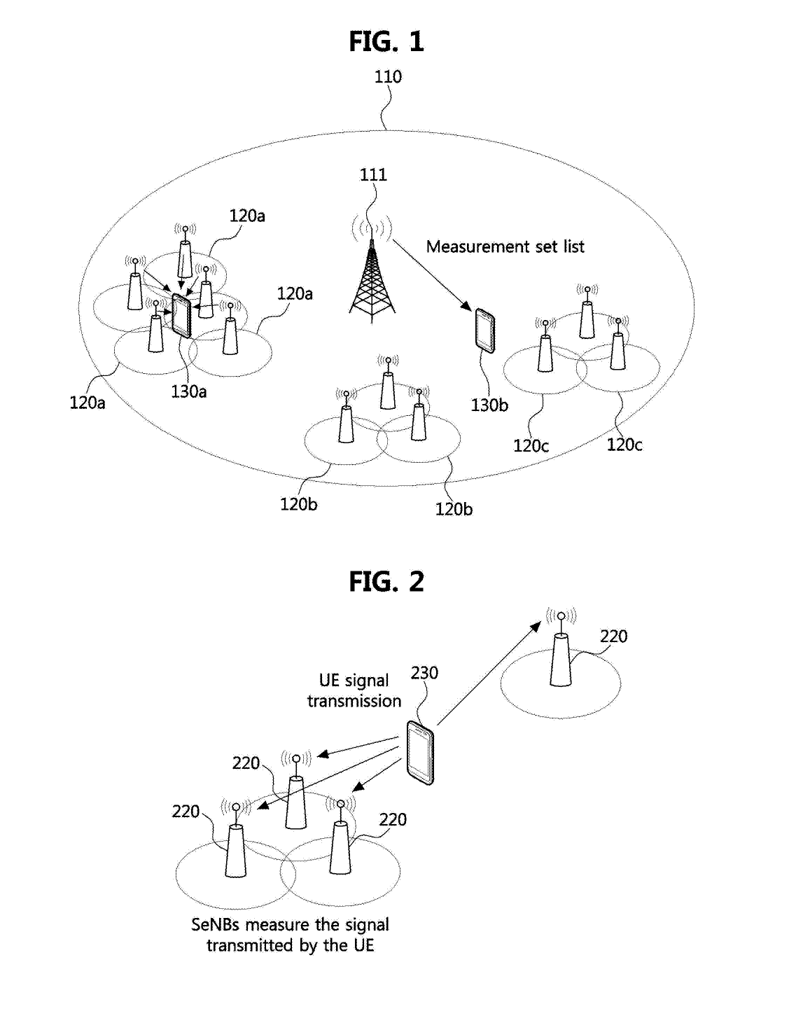

FIG. 1 is a conceptual diagram explaining a method for searching cells which are located around a terminal.

FIG. 1 represent a method in which terminals 130a and 130b search neighbor cells by measuring signals broadcasted by base stations in an environment that a plurality of small cells 120a, 120b, and 120c are located in a macro cell 110.

In a cellular communication system, a macro base station 111 generally provides a measurement set list including information about neighbor cells of the terminals 130a and 130b to the terminals 130a and 130b in order to help neighbor cell search of the terminals, and the terminals 130a and 130b may perform cell search based on the measurement set list. In the conventional cellular communication system, since only a small number of macro cells exist around a macro cell, the number of base stations constituting the measurement set list is not too large.

However, in the environment that a large number of small cells 120a, 120b, and 120c co-exist in a macro cell 110, since the macro base station 110 does not have information on a position of a terminal so that the macro base station 110 has difficulty in identifying small cells located around the terminal, the number of small cells constituting the measurement set list should be increased.

Also, in the case that a terminal 130a located in an area of the small cells moves between small cells 120a, the terminal 130a is required to measure signals transmitted from the large number of small cell base stations 120a, and amount of information to be reported to a serving base station and small cell base stations should be increased due to frequent changes of received signals.

The increase of the measurement set list size, the increase of the number of small cells, and the frequent reports on measurement may increase overhead of the system and the terminals, and increase power consumption of the terminals.

In order to solve the above-described problem in the cell search method based on measurements of forward signal (that is, downlink signal) transmitted from a base station, the present invention provides a cell search method based on measurements of backward signal (that is, uplink signal) transmitted from a terminal

FIG. 2 is a conceptual diagram explaining a small cell search method based on uplink signal measurements.

In FIG. 2, a cell search method, in which at least one small cell base stations 220 measure a signal transmitted from a terminal 230 and a cell most suitable to a service for the terminal 230 is selected, is represented.

In order to apply the above-described cell search method to a cellular communication system, a terminal 230 is required to have a capability of transmitting a unique signal differentiated from those of other terminals. Also, each of small cell base stations 220 can receive signals transmitted for a plurality of terminals respectively. That is, the terminal 230 should have a dedicated signal for multi-cell which can be identified by the plurality of small cell base stations 220.

The present invention provides a method for a plurality of small cells to distinguish signals transmitted from terminals, and a method for selecting a best suitable small cell based on the received signal.

Meanwhile, a case in which the macro base station and small cell base stations are installed in fixed points and terminals move is illustrated in FIGS. 1 and 2. However, a technical spirit of the present invention is not restricted to the above example depicted in FIGS. 1 and 2. That is, the technical scope of the present invention may be applied to a case in which a terminal searches mobile base stations, or a mobile base station searches other neighbor mobile or fixed (stationary) base stations.

The present invention provides a method in which a plurality of small cells can distinguish and measure signals transmitted from terminals, and a candidate small cell or serving small cell for serving a terminal is determined on the measurements. Also, the present invention also provides an operating method of a user equipment (UE), a macro base station (eNB; enhanced Node-B), and a small cell base station (SeNB; Small Cell eNB).

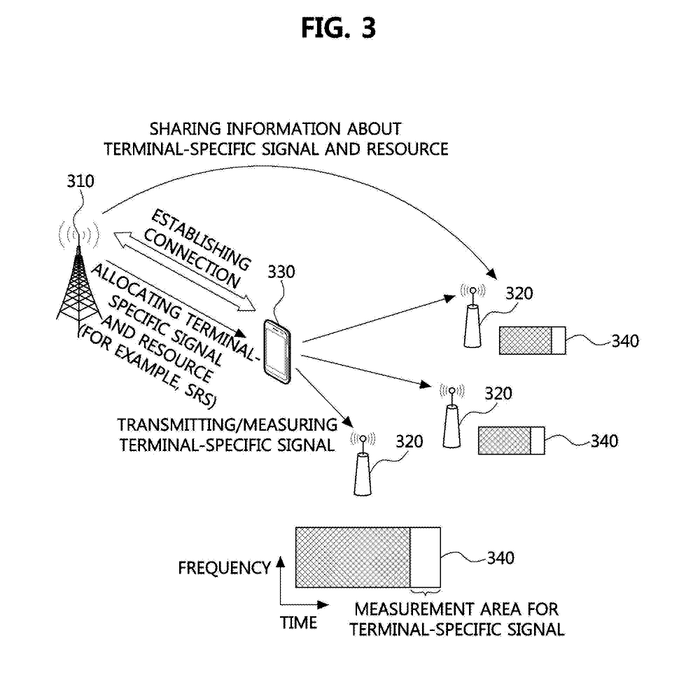

FIG. 3 is a conceptual diagram illustrating a method for small cell search according to an example embodiment of the present invention.

In FIG. 3, an operation that a terminal is allocated and transmits a terminal-specific signal which can be received by a plurality of small cells simultaneously, and a plurality of small cells around the terminal receive the terminal-specific signal transmitted from the terminal is represented conceptually.

Referring to FIG. 3, in the environment that a macro cell and a plurality of small cells exist together, a terminal 330, which establishes a connection with a macro base station (or, a macro cell) 310 and is provided with services from the macro cell, may be allocated a terminal-specific backward signal from the macro base station 310. Here, the terminal-specific backward signal may be, for example, a backward sounding reference signal (SRS) in the macro cell. The SRS may be utilized as the terminal-specific backward signal, that is, means for estimating a backward channel between the terminal and the macro base station. If the macro base station has information on its cell area and information about neighbor small cell base stations 320 in advance, the macro base station 310 shares the information about the terminal-specific signal such as the SRS allocated to the terminal 330 with corresponding small cell base stations 320 by transmitting the information the small cell base stations 320 via wired or wireless backhaul.

When the small cell base stations 320 receives the information about the terminal-specific signal of the terminal 330 from the macro base station 310, the small cell base stations 320 store the information. Also, the small cell base stations 320 observe whether the terminal-specific signal is received. If the terminal-specific signal is received, the terminal 330 which can be provided with services by a small cell may be recognized by measuring the corresponding terminal-specific signal. Here, a resource through which the terminal-specific signal is transmitted may be preconfigured by base stations 310 and 320, or be predefined in related standard specification.

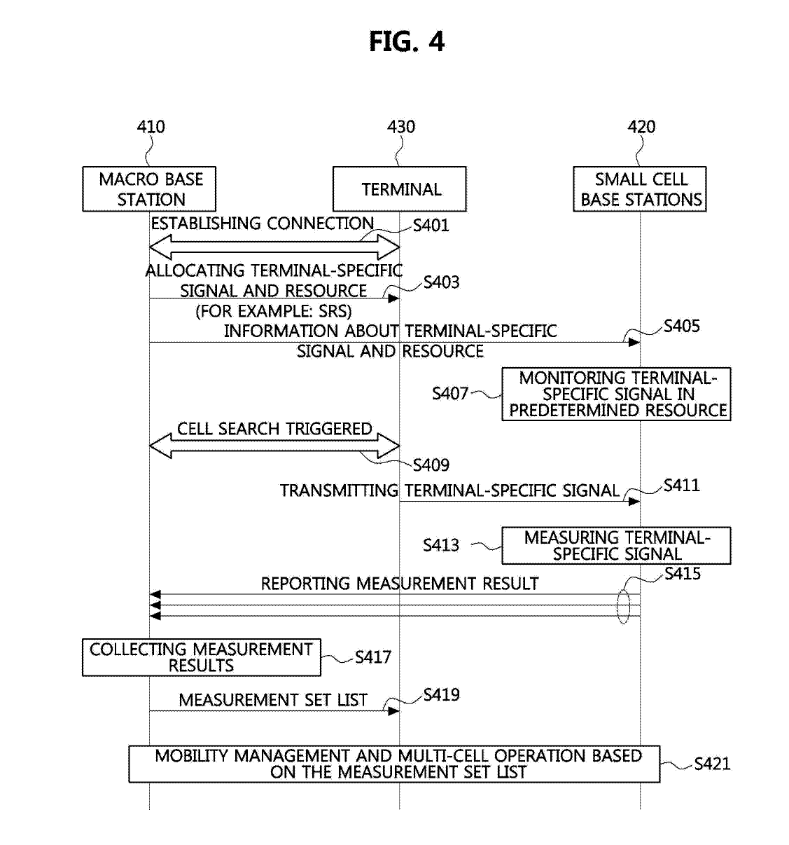

FIG. 4 is a flow chart illustrating a method for small cell search according to an example embodiment of the present invention.

Referring to FIG. 4, a terminal 430 establishes a connection with a macro base station 410, and is provided with services from the macro base station (S401).

The terminal 430 being provided with services from the macro base station 410 may be allocated a terminal-specific signal for it and a resource for transmitting the terminal-specific signal from the macro base station 410 (S430). Here, it is preferred that the terminal-specific signal is configured as a unique signal which a plurality of small cells not a single small cell can distinguish the terminal by it, that is a unique signal predefined by the macro cell and the plurality of small cells. That is, a terminal-specific signal according to the present invention may be regarded as a multi-cell terminal-specific signal. In the example depicted in FIG. 4, a case in which the SRS allocated to the terminal 430 by the macro base station 410 is used as a multi-cell terminal-specific signal is illustrated. Although the SRS is a unique signal within a cell in view of a macro cell, it can be used as a multi-cell terminal-specific signal in view of a plurality of small cells.

The SRS is a signal transmitted in uplink or downlink for estimating an uplink channel in other frequencies different from frequencies through which a current uplink physical channel is transmitted. It can be transmitted periodically or non-periodically.

For example, in the case that the SRS is transmitted periodically, it can be transmitted every 2 ms (that is, once for every two subframes) or every 160 ms (that is, once for every 16 frames). Also, when the SRS is transmitted in a subframe, it can be transmitted in the last symbol of the subframe. Also, the SRS can be transmitted by using wide frequency band so as to estimate channel quality of whole frequency bands of interest, or it can be transmitted through a small frequency band by using frequency hopping so that the whole frequency bands can be estimated by combining the SRSs transmitted through the small frequency bands.

In order to prevent collisions between uplink data transmission from other terminals and the SRS transmitted from a specific terminal, terminals should not transmit uplink data in an OFDM symbol through which the SRS is transmitted. For this, each terminal may be configured not to transmit uplink data in a last OFDM symbol of a subframe known as a subframe through which the SRS is transmitted by other terminal. Information about subframes through which the SRSs are transmitted may be delivered to terminals as system information.

On the other hand, in order to allocate unique SRS respectively to each of the terminals, SRS orthogonal to each other may be generated by using a different cyclic shift value. That is, a plurality of SRSs may be transmitted in the same subframe by using applying different cyclic shifts to SRSs transmitted from terminals. Alternatively, as another method for allocating a unique SRS for each of the terminals, a method of applying other frequency shifts to different SRSs, that is, a method of frequency multiplexing, may also be used.

On the other hand, in the case that the SRS is transmitted non-periodically, a frequency structure for transmitting SRS may be configured identically to that of the periodic SRS transmission. Also, the non-periodic SRS may also be transmitted in the last symbol of the subframe similarly to the case of the periodic SRS transmission. A transmission time of the non-periodic SRS may be configured for each terminal via upper layer signaling. In the case of non-periodic SRS transmissions, a terminal is configured not to transmit SRS actually until it receives an explicit SRS transmission trigger signal. to When the terminal receives the explicit SRS transmission trigger, it may transmit non-periodic SRS once in a next SRS transmission time by using preconfigured frequency area parameters. Also, the terminal may perform SRS transmissions additionally when additional SRS transmission triggers are received.

Re-referring to FIG. 4, in order that a SRS is recognized as a terminal-specific signal by a plurality of small cells, a macro base station 410 may transmit information related to the SRS (or, information about allocation of resources for the SRS) to the small cell base stations 420 via wired or wireless backhaul (S405). Here, the information related to the SRS may, for example, include resource allocation information such as a bandwidth for SRS transmission, a hopping bandwidth, a position on frequency region, a frequency shift, a cyclic shift, a period in a time domain, a subframe offset, and so on.

The above-described parameters for configuring SRS may be determined by negotiations between the macro base station 410 and small cell base stations 420, or may be defined in standard specifications.

The small cell base stations 420 receiving the information related to the SRS of the specific terminal 430 from the macro base station 410 may store the received information, and perform operations for recognizing the specific terminal based on the corresponding signal (S407). That is, the small cell base stations 420, receiving the information about the backward terminal-specific signal of the specific terminal 430 from the macro base station 410, may perform monitoring on whether the terminal-specific signal is received through a preconfigured resource area. Here, the small cell base stations 420 may perform detection of the terminal-specific signal in the preconfigured resource area periodically or non-periodically.

As described above, in a situation that the macro base station 410 and the small cell base stations 420 share the information about the terminal-specific signal of the terminal 430, when a terminal centric cell search is triggered due to a reason such as movement of the terminal 430 (S409), the terminal 430 may transmit the terminal-specific signal (for example, SRS) allocated from the macro base station 410 (S411).

When the plurality of small cell base stations 420 receive the multi-cell terminal-specific signal transmitted from the terminal 430, the plurality of small cell base stations 420 perform measurements on the received terminal-specific signal, and obtain information for configuring relationship between the terminal 430 and the small cell base stations (S413).

Each of the small cell base stations 420 may report measurement result information to the macro base station 410 via wired or wireless backhaul (S415). Here, the small cell base stations 420 may measure instantaneous reception power of the received terminal-specific signal (for example, SRS). Also, the small cell base stations 420 may perform measurements on the terminal-specific signals two or more times, and obtain an average value of the measurements so as to acquire a measurement fast fading effect of which is removed and report the acquired averaged measurement value to the macro base station 410.

The macro base station 410 may collect measurement information based on measurement results reported from the plurality of small cell base stations 420 (S417).

The macro base station 410 or an apparatus determining a serving cell of the terminal 430 may form a candidate set of small cells corresponding to the terminal 430 based on the collected measurement information. Here, the candidate set may be transmitted to the terminal in a form of a measurement set list for the terminal (S419).

Specifically, the macro base station 410 may form the candidate set by selecting small cell base stations reception power of which is equal to or over a predetermined threshold value Pₜₕ and constituting the candidate set including the selected small cell base stations. For example, when a wireless channel between the terminal 430 and i^{th} small cell base station is hᵢ and a transmission power of the terminal 430 is P, a reception power in the i^{th} small cell base station is Phᵢ. Accordingly, the candidate set C may be configured according to the following equation 1.

C={i|Phᵢ>Pₜₕ} [Equation 1]

In the case that a serving small cell is to be determined, a small cell satisfying the following equation 2 may be set as a serving cell i*. Here, a serving small cell of the terminal 430 may be determined based on measurement results received from the plurality of small cell base stations 421 by the macro base station 410 or an apparatus determining a service small cell of the terminal.

$${i}^{*} = arg {max}_{i} {Ph}_{i} \qquad [ Equation 2 ]$$

Then, the macro base station 410, the plurality of small cell base stations 420, and the terminal 430 may perform multi-cell operations such as management on mobility of the terminal and cooperative transmission/reception of the base stations based on measurement results (S421).

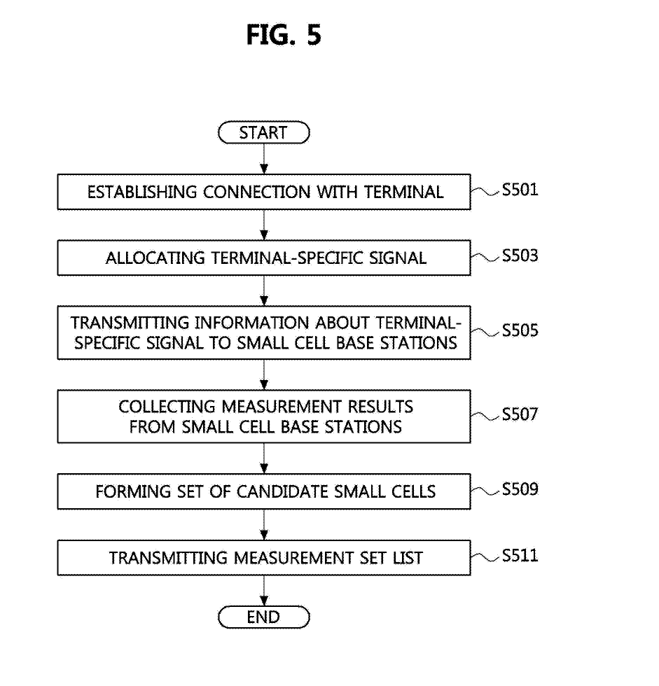

FIG. 5 is a flow chart illustrating a method performed in a macro base station in a method for cell search according to an example embodiment of the present invention.

First, the macro base station may establish a connection with a specific terminal, and provide a service to the terminal (S501).

As described above, in a state that the connection is established with the terminal, the macro base station may allocate a terminal-specific signal which can be used to differentiate the terminal from other terminals and resources for the terminal-specific signal (S503). Here, the terminal-specific signal may be a unique signal which can be recognized by a plurality of small cells, for example, a SRS. Also, the macro base station may transmit information about the terminal-specific signal and resource for the terminal-specific signal to the terminal.

The macro base station shares the information with the plurality of small cell base stations by transmitting the information about the terminal-specific signal and resource for it to the plurality of small cell base stations via wired or wireless backhaul (S505).

Then, if a cell search is triggered due to a movement of the terminal or a change of radio environments, the terminal may transmit the terminal-specific signal allocated from the macro base station. The plurality of small cell base stations may receive the terminal-specific signal transmitted from the terminal, measure the received terminal-specific signal, and report the measurement result to the macro base station. Here, the plurality of small cell base stations may repost the measurement result to the macro base station via wired or wireless backhaul.

As described above, as the small cell base stations report the measurement results to the macro base station, the macro base station may collect measurement information of the terminal-specific signal from the small cell base stations (S507).

Then, the macro base station may form a candidate set of small cells for the terminal based on the measurement information collected from the plurality of small cell base stations (S509). Here, the macro base stations may form the candidate set of small cells for the terminal by using the above equation 1.

Also, the macro base station may determine a serving small cell for the terminal. In this case, the macro base station may determine a service small cell for the terminal by using the above equation 2.

The macro base station may transmit the candidate set of small cells in a form of measurement set list to the terminal (S511).

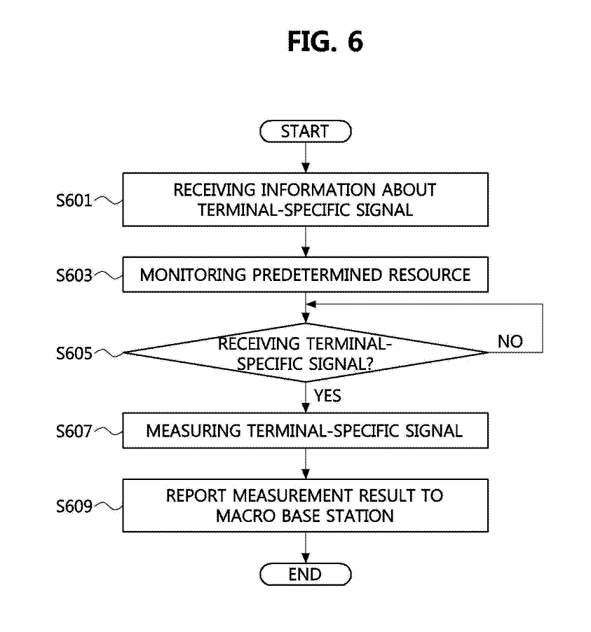

FIG. 6 is a flow chart illustrating a method performed in a small cell base station in a method for cell search according to an example embodiment of the present invention.

Referring to FIG. 6, a small cell base station may receive information about a terminal-specific signal and a resource for the terminal-specific signal from a macro base station (S601). Here, the small cell base station may receive the information from the macro base station via wired or wireless backhaul. The terminal-specific signal may be, for example, a SRS. The information about the terminal-specific signal and the resource for it may include, for example, resource allocation information such as a bandwidth for SRS transmission, a hopping bandwidth, a position on frequency region, a frequency shift, a cyclic shift, a period in a time domain, a subframe offset, and so on.

Then, the small cell base station may perform monitoring on the corresponding resource based on the received information about the terminal-specific signal and the resource (S603), and check whether the terminal-specific signal is received from the terminal (S605).

The small cell base station may perform measurement on the terminal-specific signal received from the terminal (S607). Here, the small cell base station may measure an instantaneous reception power of the terminal-specific signal. Also, the small cell base station may receive the terminal-specific signal two or more times, obtain an average value of the measured reception powers, and report the average value to the macro base station.

Then, the small cell base station may report a measurement result of the terminal-specific signal to the macro base station via wired or wireless backhaul (S609).

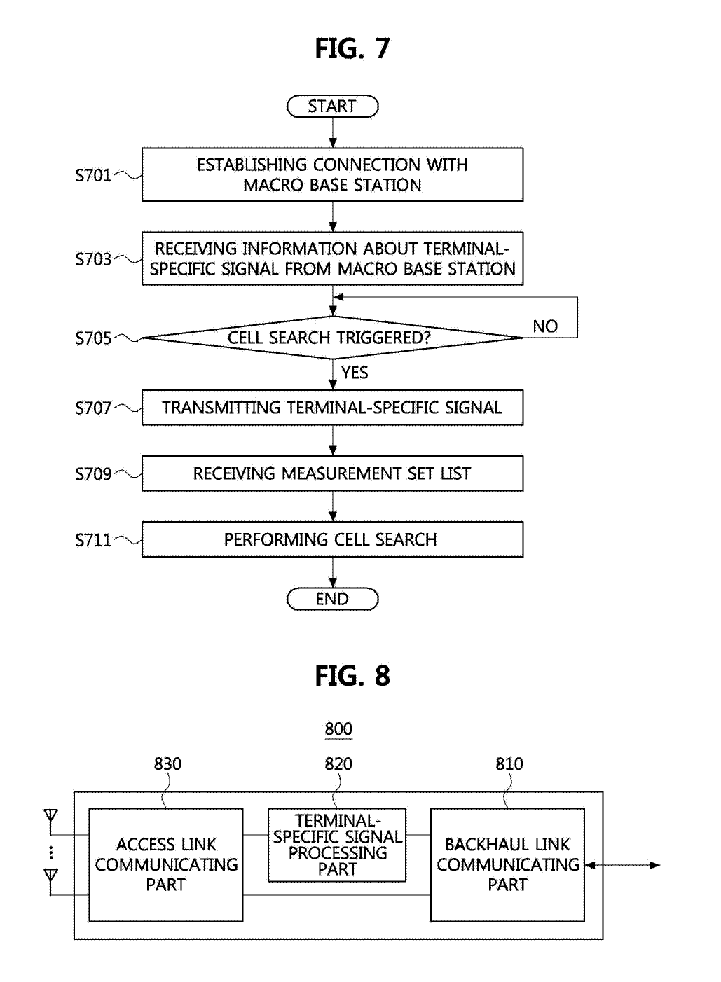

FIG. 7 is a flow chart illustrating a method performed in a terminal in a method for cell search according to an example embodiment of the present invention.

A terminal may establish a connection with a macro base station, and be provided a service from the macro base station (S701).

Then, the terminal may receive information about a terminal-specific signal allocated to the terminal from the macro base station (S703). Here, the information about the terminal-specific signal may include, for example, resource allocation information such as a bandwidth for SRS transmission, a hopping bandwidth, a position on frequency region, a frequency shift, a cyclic shift, a period in a time domain, a subframe offset, and so on.

Then, the terminal check whether a cell search is triggered (S705). Here, a trigger of the cell search may be generated according to general cell search triggering criteria. For example, the cell search may be triggered by the macro base station when the terminal moves away from the macro base station or when a channel environment between the terminal and the macro base station is getting worse.

If the cell search is triggered, the terminal may generate the terminal-specific signal by using the resource allocated from the macro base station, and transmit the generated terminal-specific signal (S707). Here, the terminal-specific signal may be a SRS.

Then, the terminal may receive information about a candidate set of small cells for the terminal, that is, information about neighbor small cell base stations around the terminal (S709). Here, the candidate set of small cells for the terminal may be provided in a form of a measurement set list, and may be configured by using the above equation 1.

The terminal may perform cell searches based on the received candidate set of small cells (S711). Here, the terminal may measure signals transmitted from small cell base stations included in the candidate set of small cells, and report measurement results to the macro base station.

FIG. 8 is a block diagram illustrating a configuration of a small cell base station performing a method for cell search according to an example embodiment of the present invention. The small cell base station illustrated in FIG. 8 may perform cell search methods described in FIG. 4 and FIG. 6.

The terminal-specific signal of the terminal, which can be recognized by a plurality of small cell base stations, should be known to the small cell base stations. In consideration of restricted resources, such the terminal-specific signal is preferred to be allocated dynamically, and information about the terminal-specific signal may be known to the small cell base stations via wired or wireless backhaul.

The small cell base station 800 according to an example embodiment of the present invention may comprise a backhaul link communicating part 810, a terminal-specific signal processing part 820, and an access link communicating part 830.

The backhaul link communicating part 810 may be configured with a wired or wireless transmission/reception interface, and configured to receive the information about the terminal-specific signal from the macro base station and transmit a measurement result of the terminal-specific signal to the macro base station.

The terminal-specific signal processing part 820 may manage the information about the terminal-specific signal obtained through the backhaul link communication part 810. Also, the terminal-specific signal processing part 820 check whether the terminal-specific signal is received by monitoring a resource allocated for the terminal-specific signal based on the information about the terminal-specific signal. Also, when the terminal-specific signal is received through the access link communicating part 830, the terminal-specific signal processing part 820 may measure the received signal and report the measured result to the macro base station via the backhaul link communicating part 810.

The access link communicating part 320 may perform communications with terminals similarly to those of the conventional base stations. Especially, the access link communicating part 830 may receive the terminal-specific signal when the terminal-specific signal is transmitted from a terminal.

In the above-described cell search method, in an environment that a plurality of small cells are located around a macro cell, a macro base station may allocate a terminal-specific signal distinguishing a terminal from other terminal to the terminal which establishes a connection with the macro base station, and share information of the terminal-specific signal with a plurality of small cell base stations. When a cell search is triggered, the terminal may transmit the allocated terminal-specific signal, and the plurality of small cell base stations perform measurements on the received terminal-specific signal and then report the measured results to the macro base station. The macro base station may configure a candidate set of small cells for the terminal based on the measurement results reported from the plurality of small cell base stations, and transmit the candidate set to the terminal.

Therefore, a terminal may search neighbor cells fast and correctly. Also, since the macro base station configures the candidate set of small cells optimized for the terminal based on the measurement results reported from the plurality of small cell base stations, overhead of cell searches in a terminal may be reduced, and power consumption of a terminal also may be reduced.

While the example embodiments of the present invention and their advantages have been described in detail, it should be understood that various changes, substitutions and alterations may be made herein without departing from the scope of the invention.

What is claimed is:

1. A cell search method performed in a terminal, the method comprising:
being allocated a terminal-specific signal from a base station; and
transmitting the terminal-specific signal when a cell search is triggered.

2. The method of claim 1, further comprising:
receiving information about a set of candidate cells corresponding to the terminal-specific signal from the base station; and
performing a cell search based on the received information about the set of candidate cells.

3. The method of claim 1, wherein the terminal-specific signal is a sounding reference signal (SRS).

4. The method of claim 1, wherein the terminal-specific signal is a unique signal of the terminal by which a plurality of small cell base stations distinguish the terminal from other terminal.

5. The method of claim 1, wherein the terminal-specific signal is configured by using a resource predetermined by the base station and a plurality of small cell base stations.

6. A cell search method performed in a base station, the method comprising:
allocating a terminal-specific signal to a terminal which establishes a connection with the base station;
transmitting information about the terminal-specific signal to a plurality of small cell base stations;
receiving measurement result information on the terminal-specific signal from the plurality of small cell base stations; and
configuring a set of candidate small cells for the terminal based on the measurement result information.

7. The method of claim 6, wherein the terminal-specific signal is a sounding reference signal (SRS).

8. The method of claim 6, wherein the set of candidate small cells includes at least one small cell base station reception power of which is larger than a predetermined threshold power among the plurality of small cell base stations.

9. The method of claim 6, further comprising transmitting information about the set of candidate small cells to the terminal, wherein the information about the set of candidate small cells is transmitted to the terminal in a form of a measurement set list.

10. The method of claim 6, further comprising determining a small cell base station having the largest reception power as a serving base station for the terminal

11. A cell search method performed in a small cell base station, the method comprising:
receiving information about a terminal-specific signal allocated to a terminal from a base station;
monitoring a resource corresponding to the terminal-specific signal based on the information about the terminal-specific signal;
when the terminal-specific signal is received, performing measurement on the received terminal-specific signal; and
transmitting a measurement result on the terminal-specific signal to the base station.

12. The method of claim 11, wherein, in the performing measurement and the transmitting a measurement result, the terminal-specific signal is received two or more times, and measurement results are obtained by performing measurements on the received measurement results, and an average value of the measurement results is obtained and reported to the base station.
